(19) United States
(12) Patent Application Publication
(10) Pub. No.: US 2003/0225351 A1
(43) Pub. Date: Dec. 4, 2003

(54) Pad structure of back roller massage device

(76) Inventor: Dong-Her Wu, Tai-Chung (TW)

Correspondence Address: Dong-Her Wu, 235 Chung-Ho Box 8-24, Taipei, TW

(21) Appl. No.: 10/158,449

(22) Filed: May 31, 2002

(51) Int. Cl. A61H 15/00

(52) U.S. Cl. 601/99; 601/100; 601/101; 601/126

(57) ABSTRACT

A pad structure of a back roller massage device comprises the following components. A bottom pad has a long concave portion. A long roller massage device is positioned at the concave portion. A plate-like frame has a size slightly larger than that of the roller massage device. The plate-like frame is exactly embedded into the concave portion of the bottom pad. A friction tolerant cloth pad has a size suitable for being placed into the plate-like frame so as to seal a top surface of the frame; thereby, the plate-like frame being tightly engaged into the concave portion of the bottom pad. The friction tolerant cloth pad completely encloses the top of the roller massage device. Only the rollers eject against the friction tolerant cloth pad so as to be formed as a top portion. Thereby, the roller massage device is hidden in the friction tolerant cloth pad.

### FIELD OF THE INVENTION

The present invention relates to massage devices, and particularly to pad structure of a back roller massage device, in that the cloth pad of the massage device can be updated easily.

### BACKGROUND OF THE INVENTION

In general, back massage devices are widely used for massaging the backs of users. Since human backs have larger areas, rollers in the massage device must move longitudinally and moreover, the rollers must be hidden effectively and provide the users with a good feeling. Therefore, a pad is provided in the massage device.

Referring to FIG. 1, conventionally, a cloth cover encloses the massage device and foams 3 are filled within the cloth cover so as to form a shape suitable for the back of the user. Moreover, referring to FIG. 1, to enhancing the effect of the cloth cover and rollers 41, the traveling path of the rollers 41 of the roller device 4 is added with a friction tolerant cloth pad 21.

However, above mentioned structure with foams 3 and cloth cover 2 has higher cost and more labor time is required to add these material in the pad of the back massage device. Moreover, it is inconvenient in repairing and updating the roller device 4 since the whole cloth cover 2 and foams 3 must be taken down.

### SUMMARY OF THE INVENTION

Accordingly, the primary object of the present invention is to provide a pad structure of a back roller massage device comprising the following components. A bottom pad has a long concave portion. A long roller massage device is positioned at the concave portion. A plate-like frame has a size slightly larger than that of the roller massage device. The plate-like frame is exactly embedded into the concave portion of the bottom pad. A friction tolerant cloth pad has a size suitable for being placed into the plate-like frame so as to seal a top surface of the frame. Thereby, the plate-like frame is tightly engaged into the concave portion of the bottom pad. The friction tolerant cloth pad completely encloses the top of the roller massage device. Only the rollers eject against the friction tolerant cloth pad so as to be formed as a top portion. Thereby, the roller massage device is hidden in the friction tolerant cloth pad.

The various objects and advantages of the present invention will be more readily understood from the following detailed description when read in conjunction with the appended drawing.

### BRIEF DESCRIPTION OF THE DRAWINGS

FIG. 1 is an exploded perspective view of the prior art structure.

FIG. 2 is an exploded perspective view of the present invention.

FIG. 3 is an assembled perspective view of the present invention.

FIG. 4 is an exploded perspective view of another embodiment of the present invention.

FIG. 5 is an exploded perspective view of the embodiment about another type of rollers used in the present invention.

FIG. 6 is an exploded perspective view of the embodiment about a further type of rollers used in the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

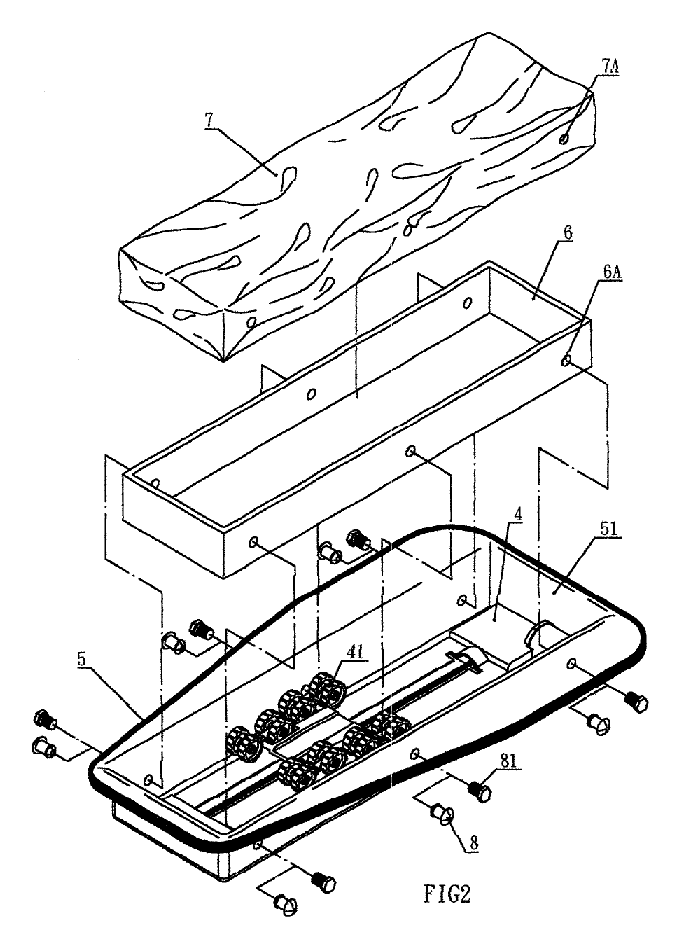

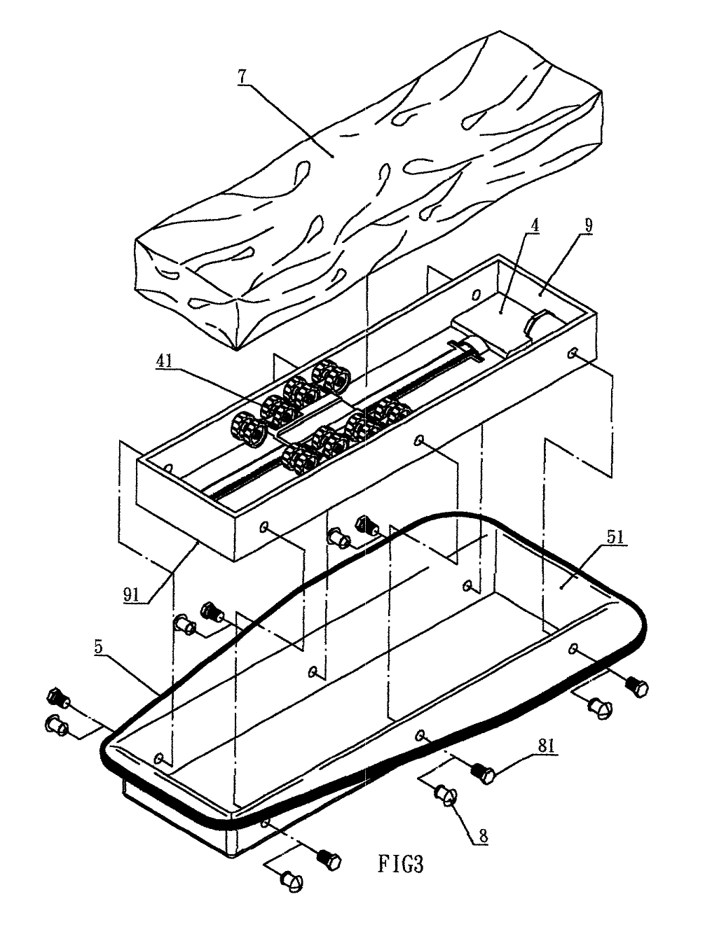

The structure and embodiments of the present invention will be described hereinafter with referring to FIGS. 2 and 3. The structure of the present invention has the following components.

A bottom pad 5 has a middle section which has a long concave portion. A massage device 4 is positioned at the interior of the concave portion 51.

A plate-like frame 6 has size slightly larger than the size of the periphery roller massage device 4. The plate-like frame 6 is exactly embedded into the concave portion 51 of the bottom pad 5.

A friction tolerant cloth pad 7 has a size suitable for being placed into the plate-like frame 6 so as to seal the top surface of the frame 6. Thereby, the plate-like frame 6 can be tightly engaged into the concave portion 51 of the bottom pad 5. The friction tolerant cloth pad 7 completely encloses the top of the roller massage device 4. Only the rollers 41 eject against the friction tolerant cloth pad 7 so as to be formed as the top portions 41A of the back massage device. Thereby, the roller massage device 4 is hidden in the friction tolerant cloth pad 7.

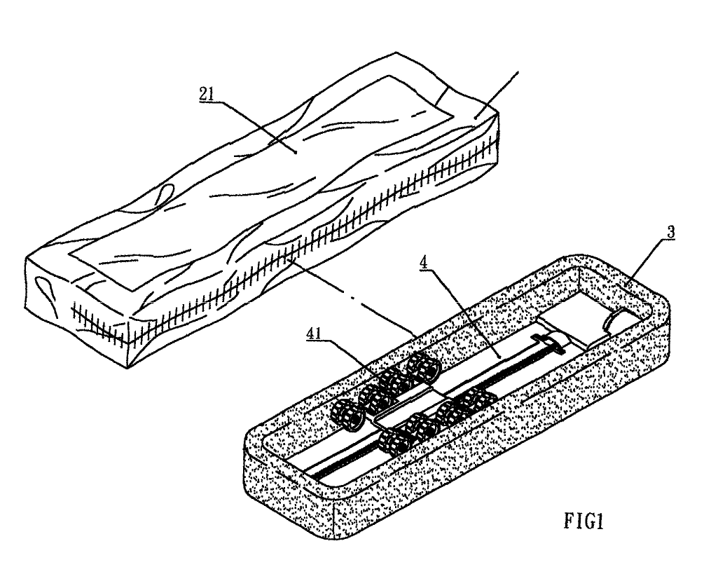

By above said structure, the user may take the plate-like frame 6 upwards so as to expose the roller massage device 4 for repairing or updating components therein (referring to FIG. 1). Likewise, after taking the plate-like frame 6 upwards, the dirty or damaged friction tolerant cloth pad 7 can be taken out for cleaning or updating (referring to FIG. 1). Thereby, the operation is more convenient and easier than the prior art structures.

Since in use, the back of the user will apply a pressure upon the plate-like frame 6 (including the assembled friction tolerant cloth pad 7) which is embedded into the concave portion 51, the plate-like frame 6 is well positioned. For further enhancing the positioning effect of the plate-like frame 6 (including the friction tolerant cloth pad 7), a plurality of movable combining studs 8 (for example, plastic studs 8, buckles or studs 81, etc.) are mounted at the outer periphery of the concave portion 51 of the bottom pad 5 through the holes 7A in the friction tolerant cloth pad 7 and holes 6A in the plate-like frame 6 to prevent the plate-like frame 6 and friction tolerant cloth pad 7 from falling out. These components are hidden in the friction tolerant cloth pad so as to present a beautiful outlook.

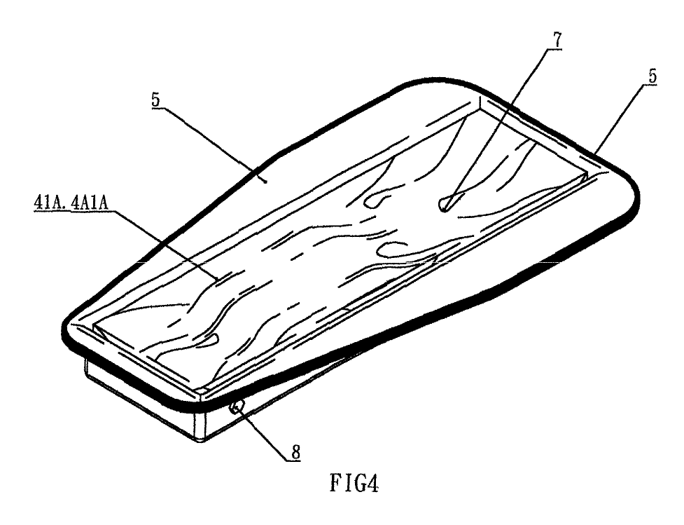

Referring to FIGS. 3 and 4, the another embodiment of the present invention is illustrated, where the roller massage device 4 is installed at the concave portion 51 of the bottom pad 5, in this embodiment, a plate-like frame 9 is used to replace the above said embodiment. The plate-like frame 9 has a support bottom seat 91. Roller massage device 4 is installed to the bottom seat 91 in advance. Then the friction tolerant cloth pad 7 is provided at the periphery of the plate-like frame 9. Then the combination structure is placed in the concave portion 51 of the bottom pad 5. Then studs 8 are used fixed the two components (referring to FIG. 3).

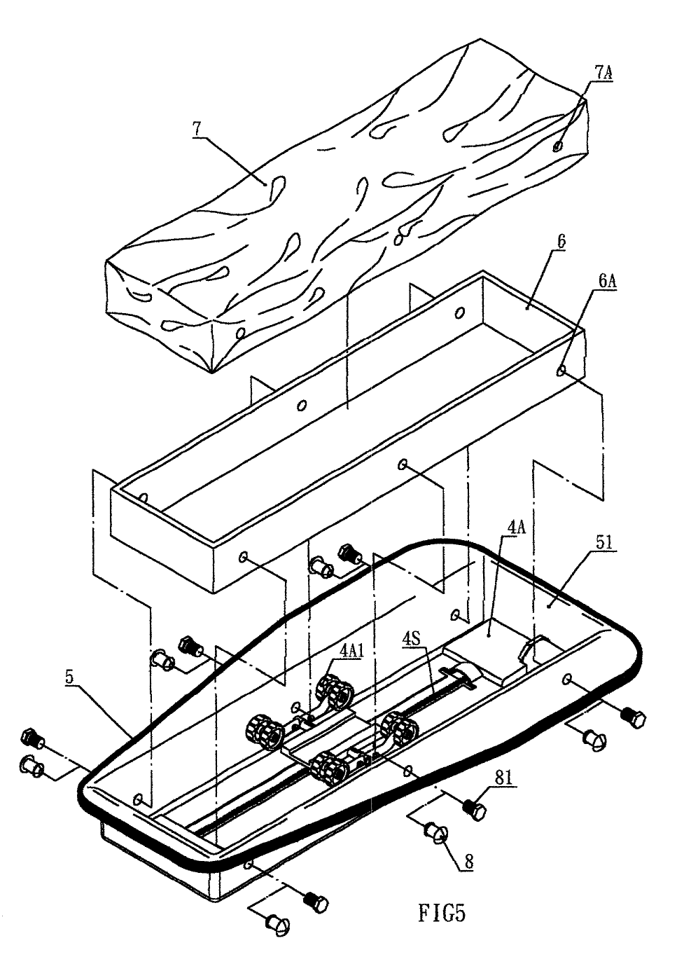

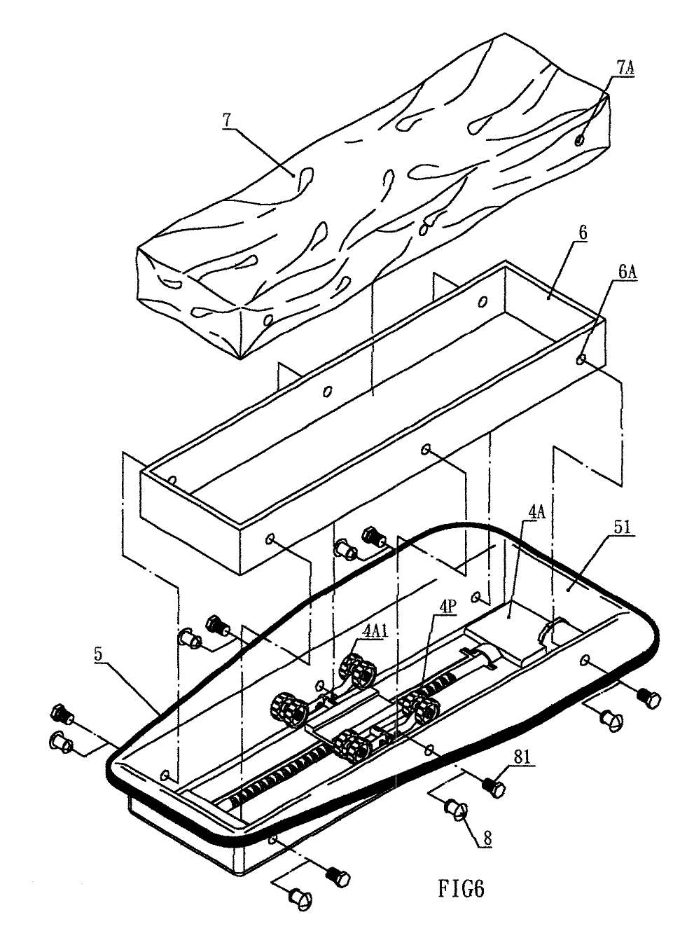

Referring to FIGS. 5 and 6, the concave portion 51 of the bottom pad 5 can be designed with the number of the rollers. For example, in FIGS. 2 to 4, more rollers 41 are used and in FIGS. 5 and 6, less rollers 4A1 are used. In FIG. 4, the rollers are driven by chain 4S, but in FIG. 6, the rollers 4A1 is driven by a threaded rod 4P1 so that that the main seat 4 may move reciprocally. The other part, such as plate-like frame 6 and friction tolerant cloth pad 7 are similar to those in the embodiment illustrated in FIGS. 2 to 4, and thus the details will not be further described herein.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A pad structure of a back roller massage device comprising:
a bottom pad having a long concave portion in a middle section thereof; a long roller massage device being positioned at an interior of the concave portion;
a plate-like frame having a size slightly larger than that of the roller massage device; the plate-like frame being exactly embedded into the concave portion of the bottom pad; and
a friction tolerant cloth pad having a size suitable for being placed into the plate-like frame so as to seal a top surface of the frame; thereby, the plate-like frame is tightly engaged into the concave portion of the bottom pad;
thereby, a friction tolerant cloth pad completely encloses a top of the roller massage device; only the rollers eject against the friction tolerant cloth pad so as to be formed as a top portion; thereby, the roller massage device is hidden in the friction tolerant cloth pad; but the friction tolerant cloth pad can be opened easily for repair and update.

2. The pad structure of a back roller massage device as claimed in claim 1, wherein a plurality of movable combining studs are mounted at an outer periphery of the concave portion of the bottom pad through the holes in the friction tolerant cloth pad and holes in the plate-like frame to prevent the plate-like frame and friction tolerant cloth pad from falling out.

3. The pad structure of a back roller massage device as claimed in claim 1, wherein the plate-like frame has a support bottom seat; roller massage device is installed to the bottom seat in advance; then the friction tolerant cloth pad is provided at the periphery of the plate-like frame; then the combination structure of the friction tolerant cloth pad and the plate-like frame is placed in the concave portion of the bottom pad; then studs are used fixed these components.
